(19) United States
(12) Patent Application Publication
(10) Pub. No.: US 2025/0267526 A1
(43) Pub. Date: Aug. 21, 2025

(54) SYSTEMS AND METHODS FOR MANAGING FIXED WIRELESS CELL CAPACITY

(71) Applicant: T-Mobile Innovations LLC, Overland Park, KS (US)

(72) Inventor: Jasinder P. SINGH, Olathe, KS (US)

(21) Appl. No.: 18/582,834

(22) Filed: Feb. 21, 2024

(51) Int. Cl. H04W 36/00; H04L 43/0882; H04W 36/08; H04W 36/22; H04W 48/06

(52) U.S. Cl. CPC H04W 36/0058; H04L 43/0882; H04W 36/08; H04W 36/22; H04W 48/06

(57) ABSTRACT

Systems and methods are provided for managing cell capacity for fixed wireless devices. An example method may include monitoring a number of fixed wireless devices on a frequency band served by an access node. If the number of fixed wireless devices on that frequency band exceeds a threshold, a notification may be transmitted to one or more neighboring access nodes. The notification may include the number of fixed wireless devices being served by the access node on the frequency band as well as the details of the frequency band that is serving the fixed wireless devices.

### TECHNICAL BACKGROUND

A wireless network, such as a cellular network, can include an access node (e.g., base station) serving multiple wireless devices including both mobile and fixed wireless devices in a geographical area covered by a radio frequency transmission provided by the access node. Access nodes may deploy different carriers within the cellular network utilizing different radio access technologies (RATs). RATs can include, for example, 3G RATs (e.g., GSM, CDMA etc.), 4G RATs (e.g., WiMax, LTE, etc.), and 5G RATs (new radio (NR)). Further, different types of access nodes may be implemented for deployment for the various RATs. For example, an evolved NodeB (eNodeB or eNB) may be utilized for 4G RATs and a next generation NodeB (gNodeB or gNB) may be utilized for 5G RATs. Deployment of the evolving RATs in a network provides numerous benefits. For example, newer RATs may provide additional resources to subscribers, faster communications speeds, and other advantages. For example, 5G networks provide edge deployments enabling computing capabilities closer to wireless devices.

Fixed wireless device may be more taxing on the provider's wireless network than typical mobile wireless devices since they tend to provide data access for multiple devices (e.g. desktop and laptop computers, tablets, smart TV's) behind the home internet router. There are times when a mobile wireless device will need to change from one access node to another, such as while moving through coverage areas of various access nodes. This handover from one access node to another can be problematic if the receiving access node is already serving multiple fixed wireless devices. The receiving access node may not have sufficient capacity to accept more devices. A better method of managing the cell capacity of cells serving fixed wireless devices.

### OVERVIEW

Examples described herein include systems and methods for managing fixed wireless cell capacity. An exemplary method includes monitoring a number of fixed wireless devices on a frequency band served by a serving access node. The method further includes determining that the number of fixed wireless devices on the frequency band served by the serving access node has exceeded a first threshold. The method further includes transmitting a notification to one or more neighboring access nodes, the notification including the number of fixed wireless devices served by the serving access node on the frequency band, and the frequency band serving the fixed wireless devices.

Another exemplary method includes receiving from an access node a count of how many fixed wireless devices the access node is serving within a cell provided by the access node. The method further includes determining that a wireless device is subject to a handover procedure. The method further includes deprioritizing the cell in a list of target cells for handover of the wireless device responsive to the count being at or above a first threshold. The method further includes completing the handover procedure for the wireless device.

Another exemplary embodiment includes a system including an access node which includes at least one electronic processor configured to perform operations. The operations include monitoring a number of fixed wireless devices on a frequency band served by the access node. The operations further include determining that the number of fixed wireless devices on the frequency band served by the access node has met or exceeded a first threshold. The operations further include transmitting a notification to one or more neighboring access nodes, the notification including the number of fixed wireless devices on the frequency band served by the access node and the frequency band serving the fixed wireless devices.

### BRIEF DESCRIPTION OF THE DRAWINGS

These and other more detailed and specific features of various embodiments are more fully disclosed in the following description, reference being had to the accompanying drawings, in which:

FIG. 1 illustrates an example system for wireless communication in accordance with various aspects of the present disclosure;

FIG. 2 illustrates an example processing node in accordance with various aspects of the present disclosure;

FIG. 3 illustrates an example access node in accordance with various aspects of the present disclosure;

FIG. 4 illustrates an example process flow for managing fixed wireless cell capacity; and

FIG. 5 illustrates an example process flow managing fixed wireless cell capacity.

### DETAILED DESCRIPTION

In the following description, numerous details are set forth, such as flowcharts, schematics, and system configurations. It will be readily apparent to one skilled in the art that these specific details are merely exemplary and not intended to limit the scope of this application.

In accordance with various aspects of the present disclosure, a wireless network may be provided by multiple access nodes. Access nodes provide wireless service to cells. A cell may be defined by a geographic region and a frequency band, such that a single access node may provide service to multiple cells differentiated by different frequency bands within a similar geographic area.

Wireless service may be provided to a wide range of wireless devices, including mobile and fixed location wireless devices. With the expansion of home internet service being provided by wireless providers through the use of cellular home internet gateways, the number of fixed wireless devices has increased. To an end user, a cellular home internet gateway looks and acts much like any other gateway provided by an internet service provider (ISP). The gateway connects to the ISP's network and then makes connections available for the customer's other devices within the home via ethernet or Wi-Fi. The difference being that the cellular home internet gateway connects to the ISP's network by way of a wireless connection rather than a wired connection such as cable or fiber. The single gateway device provides access for many other devices, such as desktop and laptop computers, tablet computers, smart TVs and other internet connected devices. This means that a fixed wireless device, such as a cellular home internet gateway, tends to demand far more traffic bandwidth than a typical mobile wireless device, such as a phone. A fixed wireless device will typically attempt to attach to the cell with the greatest bandwidth or the highest priority frequency band. This provides a good customer experience for the multiple devices connecting through the fixed wireless device.

The ISP may detect and count the fixed wireless device as a single device even though it may be using far more bandwidth than other devices on the ISP's network. For this reason, cellular ISPs may be careful in selling the home internet service to prevent overloading areas with fixed wireless devices. Additionally, a cellular ISP may want to prevent the access node serving fixed wireless devices from being overloaded in other ways. For example, an access node serving fixed wireless devices may want to limit the number of wireless devices it accepts during handovers from other access nodes.

As mobile wireless devices travel around, they move from cell to cell. There is a handover procedure when a wireless device moves from one cell to another. The handover procedure may also be triggered if there is a significant drop in signal strength or quality between the wireless device and its current cell. A wireless device will continuously measure the signal strength and quality of the access nodes it can communicate with. When the signal strength or quality to the current cell of an access node drops low enough and the signal strength or quality to a different cell often provided by a neighboring access node is high enough, a handover may be triggered. The network will select a target cell from amongst the cells available to the wireless device and then transfer the wireless device to the target cell.

The handover procedure is not limited to wireless devices that are moving from one cell to another. It could be triggered in other situations, some examples of which follow here. There could be an obstruction between the wireless device and a cell of its current access node, such as when a user of a mobile phone walks next to a tall building that obstructs the signal from one direction. There could be inclement weather in one direction from the wireless device causing reduced signal strength to cells of access nodes in that direction, but not cells of access nodes in the opposite direction. An access node could go offline, causing all devices connected to handover to different access nodes. A new access node could go online with a cell of better signal strength and quality for the wireless device causing it to handover to the new access node.

An access node looking for target cells to handover a wireless device doesn't have a good way of factoring fixed wireless devices into the choice of a target cell for the handover. During the information exchange (IE) between access nodes, each access node learns the capabilities and current status of its neighboring access nodes. This IE communication may be delivered over the X2/Xn interface between access nodes, for example. The IE procedures and information provided are defined by 3GPP standards. Adding some new information to the IE process may improve the capacity management of cells serving fixed wireless devices.

An access node serving fixed wireless devices may transmit to its neighboring access nodes information including the number of fixed wireless devices it is currently serving and the frequency bands on which they are being served. A neighboring access node could then factor that information into choosing a target cell for handovers of wireless devices. For example, an access node may be serving multiple fixed wireless devices on a particular cell. It sends out a notification stating how many fixed wireless devices it is serving and the details of the cell they are being served on. The notification may also contain an indication whether or not the serving access node is accepting handovers for the cell currently serving the fixed wireless devices. A neighboring access node may receive this information and when the neighboring access node is forming a list of target cells to handover a wireless device that it is currently serving, it might see the number of fixed wireless devices in a particular cell is high and decide to deprioritize (lower its priority within the target list) that cell or even exclude that cell from its target list of cells. Alternatively, the neighboring access node may receive a notification that the serving cell is not accepting handover devices and then exclude the cell from the list of target cells. In this way, handovers to cells with high fixed wireless traffic can be minimized or prevented. This may lead to an improved customer experience for both the fixed wireless users and the wireless devices users.

The transmission of this information may be highly configurable. It may be periodic with a predetermined schedule. It may be set to occur at a fixed frequency, or the frequency may be adjustable based on network conditions. For example, it may occur at one frequency while the number of fixed wireless devices being served on a cell is at or below a threshold but change the frequency if the number goes above the threshold. Similarly, the frequency may change based on different levels of traffic on the cell or cells serving the fixed wireless devices, where the frequency is changed based on whether or not the change in traffic is above or below a threshold. It may be triggered by specific events. For example, when a change in the number of fixed wireless devices being served by a cell happens, it may trigger an instance of the serving access node transmitting the new number of fixed wireless devices it is serving and the cells they are being served on. In another example, it could be triggered at traffic thresholds. For example, if the amount of traffic on the cell or cells being used by the fixed wireless devices changes significantly, it could trigger a transmission regardless of whether or not the number of fixed wireless devices has changed.

Many variations of this scheme may be implemented. For example, the decision to deprioritize or exclude a cell serving fixed wireless devices may be made based on the traffic level within the cell or a combination of the traffic level and the number of fixed wireless devices. For example, a cell serving some fixed wireless devices, but with a low traffic level may have the capacity to add wireless devices without adversely impacting the user experience of the wireless devices being served by the cell. Conversely, a cell serving a single fixed wireless device may have a sufficiently high traffic level that adding even a single new wireless device would adversely impact the wireless devices served by the cell.

The number of fixed wireless devices served by a cell may change with fixed wireless devices going online or offline or if they change to a different cell served by the same or different access node. The fixed wireless devices themselves are still capable of handovers to other cells when conditions dictate. The traffic level on a cell may change significantly over time for various reasons as well. For example, traffic overnight tends to be lower than during the day. Even if the number of fixed wireless devices stays the same, the lower traffic overnight would allow the cells serving the fixed wireless devices to have the capacity to accept handovers of other devices.

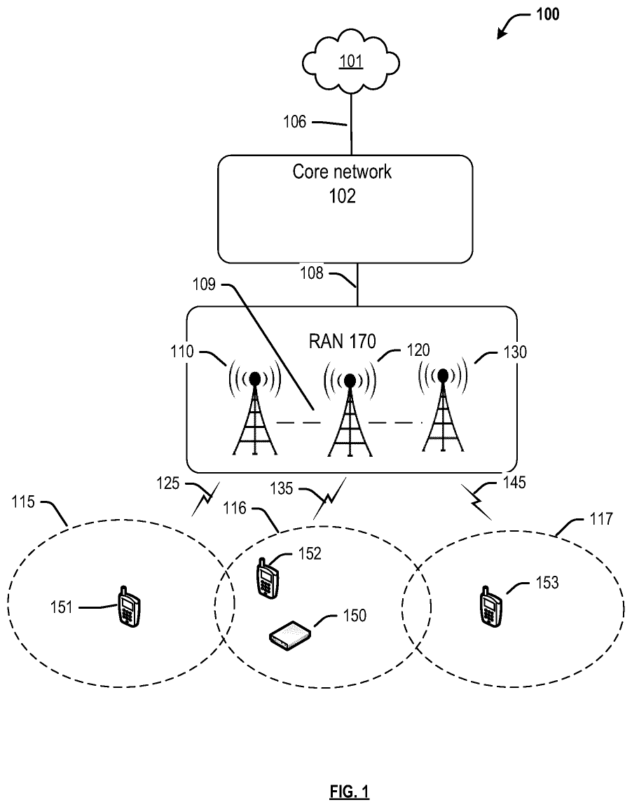

FIG. 1 depicts an exemplary system 100 for wireless communication, in accordance with the disclosed embodiments. The system 100 may include a communication network 101, core network 102, network connection 106, communication link 108, X2/Xn link 109, and a radio access network (RAN) 170 including access nodes 110, 120, and 130. The RAN 170 may include other devices and additional access nodes. Although three access nodes are shown, any number of access nodes may be included.

The system 100 also includes fixed wireless device 150 and multiple mobile wireless devices 151-153, which may be end-user wireless devices and may operate within one or more cells 115, 116, and 117. The wireless devices 150-153 communicate with access nodes 110, 120, and/or 130 within the RAN 170 over communication links 125, 135, and 145, which may for example be 5G NR communication links, 4G LTE communication links, or any other suitable type of communication link.

Access nodes 110, 120, and 130 can be, for example, standard access nodes such as a macro-cell access node, a base transceiver station, a radio base station, an eNodeB device, an enhanced eNodeB device, a next generation NodeB (or gNodeB) in 5G New Radio (“5G NR”), or the like. In additional embodiments, access nodes 110, 120, and 130 may comprise two co-located cells, or antenna/transceiver combinations that are mounted on the same structure. Alternatively, access nodes 110, 120, and 130 may comprise a short range, low power, small-cell access node such as a microcell access node, a picocell access node, a femtocell access node, or a home eNodeB device.

The access nodes 110, 120, and 130 can comprise a processor and associated circuitry to execute or direct the execution of computer-readable instructions to perform operations such as those further described herein. Access nodes 110, 120, and 130 can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

Each of wireless devices 150-153 may be capable of simultaneously communicating with the RAN 170 using combinations of antennae via 4G and 5G or any other RAT or transmission mode, including multiple carriers. For instance, MU-MIMO pairings and SU-MIMO pairings can be made by wireless devices 150-153. It is noted that any number of access nodes, antennae, MU-MIMO pools, carriers, and wireless devices (both fixed and mobile) may be implemented.

Wireless devices 150-153 may be any device, system, combination of devices, or other such communication platform capable of communicating on the wireless network using one or more frequency bands deployed therefrom. Wireless devices 150-153 may be divided into two categories for the purposes of this disclosure. Fixed wireless device 150 may be a cellular home internet modem, for example. Mobile wireless devices 151-153 may be, for example, mobile phones, wireless phones, personal digital assistants (PDA), tablet computers, as well as other types of devices or systems that can exchange audio or data via the wireless network but are not considered fixed wireless devices.

In operation, system 100 may be configured to execute a method including monitoring a number of fixed wireless devices 150 in a cell 116 served by an access node 120. If it is determined that the number of fixed wireless devices 150 has exceeded a threshold number, the access node 120 may transmit a notification to its neighboring access nodes 110 and 130. This notification may include the number of fixed wireless devices 150 that the access node 120 is currently serving within the cell 116, and the frequency band the cell 116 is operating on. The notification may optionally contain an indication whether or not the access node 120 is accepting handovers of other wireless devices 151-153 for the cell 116 serving the fixed wireless device 150. The notification may be triggered again if the number of fixed wireless devices 150 drops to be at or below the threshold and that notification may optionally include an indication that the cell 116 is again accepting handovers of wireless devices.

The notification including the number of fixed wireless device 150 served by a cell 116 and the frequency band of that cell 116 may be configured to occur on a predetermined schedule. That schedule may be determined by the cellular network provider, for example. The schedule may also be modifiable in real time by the serving access node 120 itself. For example, the schedule may be changed or stopped based on the number of fixed wireless devices 150 on the cell 116, the addition or subtraction of fixed wireless devices 150 on the cell 116, an increase or decrease in traffic on the cell 116, or a combination of any of these scenarios.

System 100 may further include many components not specifically shown in FIG. 1 including processing nodes, controller nodes, routers, gateways, and physical and/or wireless data links for communicating signals among various network elements. System 100 may include one or more of a local area network, a wide area network, and an internetwork (including the Internet). System 100 may be capable of communicating signals and carrying data, for example, to support voice, push-to-talk, broadcast video, and data communications by wireless devices 150-153. Wireless network protocols may include one or more of Multimedia Broadcast Multicast Services (MBMS), code division multiple access (CDMA) 1×RTT (radio transmission technology), Global System for Mobile communications (GSM), Universal Mobile Telecommunications System (UMTS), High-Speed Packet Access (HSPA), Evolution Data Optimized (EV-DO), Worldwide Interoperability for Microwave Access (WiMAX), Third Generation Partnership Project Long Term Evolution (3GPP LTE), Fourth Generation broadband cellular (4G, LTE Advanced, etc.), and Fifth Generation mobile networks or wireless systems (5G, 5G New Radio (“5G NR”), or 5G LTE). Wired network protocols utilized by communication network 101 may include one or more of Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM).

Other network elements may be present in system 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements.

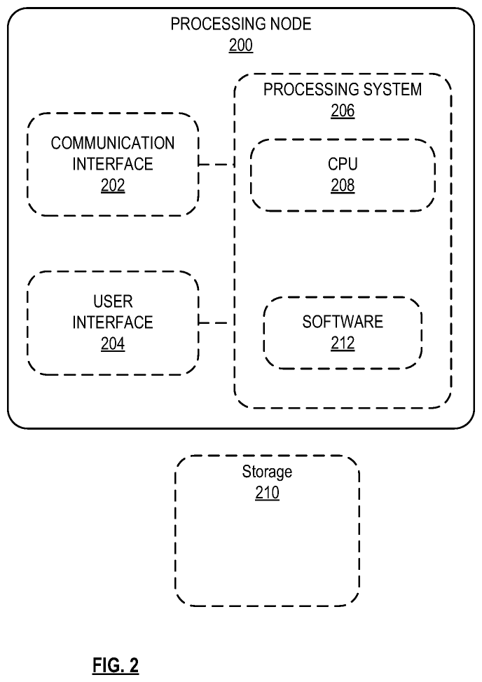

FIG. 2 depicts an exemplary processing node 200, which may be configured to perform the methods and operations disclosed herein to manage cell capacity for fixed wireless devices. The processing node 200 includes a communication interface 202, user interface 204, and processing system 206 in communication with communication interface 202 and user interface 204. Processing system 206 includes a processor 208, storage 210, which can comprise a disk drive, flash drive, memory circuitry, or other memory device including, for example, a buffer. Storage 210 can store software 212 which is used in the operation of the processing node 200. Software 212 may include computer programs, firmware, or some other form of machine-readable instructions, including an operating system, utilities, drivers, network interfaces, applications, or some other type of software. Processing system 206 may include a processor 208 and other circuitry to retrieve and execute software 212 from storage 210. Processing node 200 may further include other components such as a power management unit, a control interface unit, etc., which are omitted for clarity. Communication interface 202 permits processing node 200 to communicate with other network elements. User interface 204 permits the configuration and control of the operation of processing node 200.

In an exemplary embodiment, software 212 can include instructions for monitoring a number of fixed wireless devices on a frequency band served by an access node. The instructions may further include determining that the number of fixed wireless devices on the frequency band served by the access node has exceeded a first threshold. The instructions may further include transmitting a notification to one or more neighboring access nodes, the notification including the number of fixed wireless devices on the frequency band served by the access node, and the frequency band serving the fixed wireless devices. The notification may optionally contain an indication whether or not the access node is accepting handovers of other wireless devices for the frequency band serving the fixed wireless device. The notification may be triggered again if the number of fixed wireless devices drops to or below the threshold and that notification may optionally include an indication that the access node is again accepting handovers of wireless devices for the frequency band.

The notification including the number of fixed wireless device served by a cell and the frequency band of that cell may be configured to occur on a predetermined schedule. That schedule may be determined by the cellular network provider. The schedule may also be modifiable in real time by the serving access node itself. For example, the schedule may be changed or stopped based on the number of fixed wireless devices on the frequency band, the addition or subtraction of fixed wireless devices on the frequency band, an increase or decrease in traffic on the frequency band, or a combination of any of these scenarios.

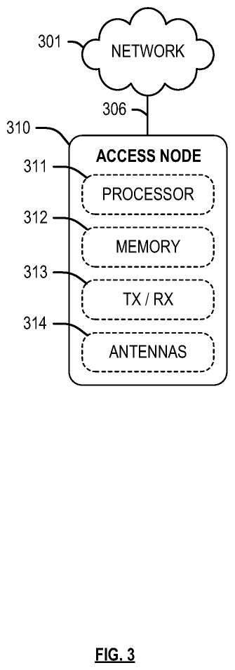

FIG. 3 depicts an exemplary access node 310 for providing wireless service in wireless networks. Access node 310 is configured as an access point for providing network services from network 301 to wireless devices such as wireless devices 150-153 in FIG. 1. Access node 310 is illustrated as comprising a processor 311, a memory 312 for storing logical modules that perform operations described herein, and one or more transceivers 313 for transmitting and receiving signals via antennae 314. Combination of antennae 314 and transceivers 313 are configured to deploy one or more radio air interfaces using different RATs, frequencies, and/or operating modes. Additional transceivers and antennae may be incorporated in order to deploy 4G, 5G, mm-wave, SU-MIMO, MU-MIMO or massive MU-MIMO data streams to wireless devices attached to access node 310, as well as to facilitate communication with other network nodes on network 301. Further, access node 310 is communicatively coupled to network 301 via communication interface 306, which may be any wired or wireless link as described above. The one or more antennae 314 can include any combination of: antennae associated with different radio access technologies (RATs) (including 3G, 4G, 5G, 5G sub 6G, 5G millimeter wave), antennae associated with different arrays (including 2×2, 4×2, 4×4, 8×8, 16×16, 32×32, 64×64, 128×128, and so on), and beamforming antennae.

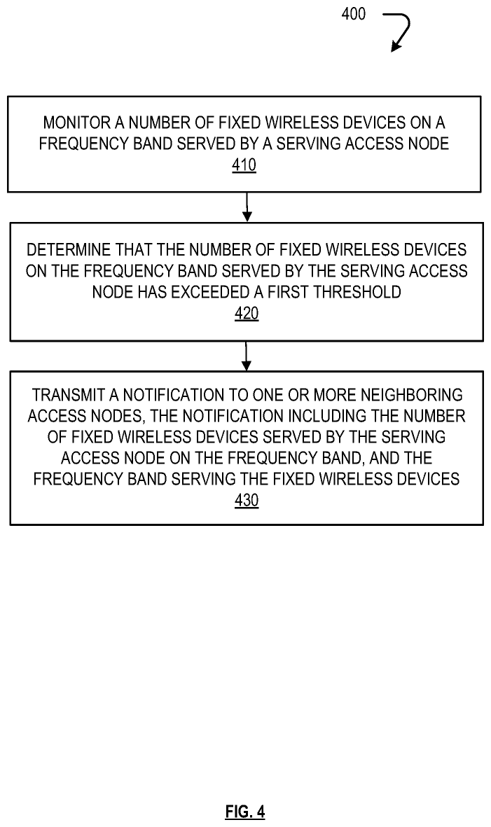

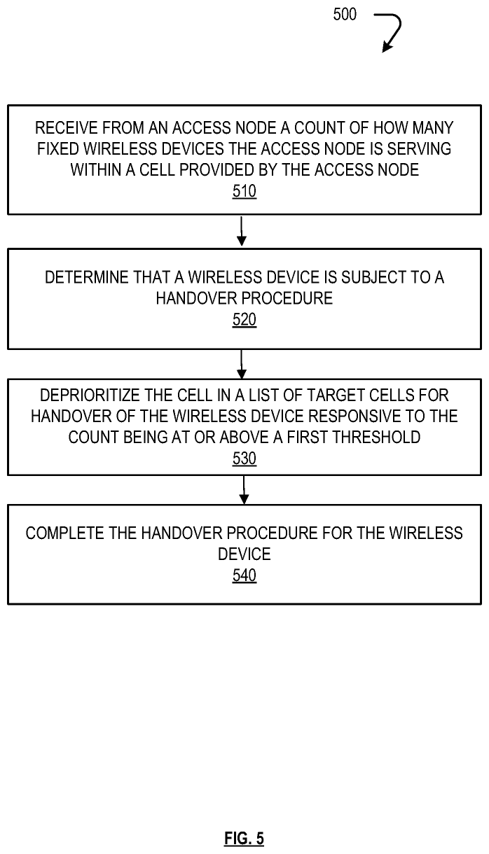

Access node 310 may be configured to perform the methods described herein including the methods described with respect to FIG. 4 and FIG. 5. The processor 311 of access node 310 may be configured to perform the instructions described herein including those described with respect to the processing node 200 of FIG. 2.

FIG. 4 illustrates an exemplary method 400 for managing cell capacity for fixed wireless devices. Method 400 can be implemented by any suitable combination of processors, such as processing node 200. Although FIG. 4 depicts steps performed in a particular order for purposes of illustration and discussion, the operations discussed herein are not limited to any particular order or arrangement. One skilled in the art, using the disclosures provided herein, will appreciate that various steps of the methods can be omitted, rearranged, combined, and/or adapted in various ways.

Method 400 begins in step 410 where a number of fixed wireless devices on a frequency band served by a serving access node is monitored. Method 400 continues in step 420 where it is determined that the number of fixed wireless devices on the frequency band served by the serving access node has exceeded a first threshold. Method 400 continues in step 430 where a notification is transmitted to one or more neighboring access nodes. The notification including the number of fixed wireless devices served by the serving access node and the frequency band serving the fixed wireless devices. The notification may optionally contain an indication whether or not the access node is accepting handovers of other wireless devices for the frequency band serving the fixed wireless device. The notification may be triggered again if the number of fixed wireless devices drops below the threshold and that notification may optionally include an indication that the access node is again accepting handovers of wireless devices for the frequency band.

The notification including the number of fixed wireless device served by a cell and the frequency band of that cell may be configured to occur on a predetermined schedule. That schedule may be determined by the cellular network provider. The schedule may also be modifiable in real time by the serving access node itself. For example, the schedule may be changed or stopped based on the number of fixed wireless devices on the frequency band, the addition or subtraction of fixed wireless devices on the frequency band, an increase or decrease in traffic on the frequency band, or a combination of any of these scenarios.

FIG. 5 illustrates an exemplary method 500 for managing fixed wireless device cell capacity. Method 500 can be implemented by any suitable combination of processors, such as processing node 200. Although FIG. 5 depicts steps performed in a particular order for purposes of illustration and discussion, the operations discussed herein are not limited to any particular order or arrangement. One skilled in the art, using the disclosures provided herein, will appreciate that various steps of the methods can be omitted, rearranged, combined, and/or adapted in various ways.

Method 500 may be implemented at an access node such as a neighboring access node as discussed above in relation to method 400, for example. Method 500 begins in step 510 where a count of how many fixed wireless devices the access node is serving within a cell provided by the access node is received. Method 500 continues in step 520 where it is determined that a wireless device is subject to a handover procedure. Method 500 continues in step 530 where the cell is deprioritized in a list of target cells for handover of the wireless device responsive to the count being at or above a first threshold. Method 500 continues in step 540 where the handover procedure is completed for the wireless device, the wireless device being handed over to an access node in accordance with the handover procedure.

In addition to the count of how many fixed wireless devices the access node is serving within a cell provided by the access node, the information received from the access node may also include the frequency band of that cell. The information may also include an indication of whether or not the access node is accepting handovers for the cell. If the number of fixed wireless devices in a cell is determined to be at or above a second threshold, the cell may be excluded from the list of target cells for handover procedures. However, if the number of fixed wireless devices is below the threshold, the cell may be set to a normal priority for the purposes of the target list of cells for possible handovers. The information may be provided on a fixed or dynamic schedule or after triggering events.

In some embodiments, methods 400 and 500 may include additional steps or operations. Furthermore, the methods may include steps shown in each of the other methods. As one of ordinary skill in the art would understand, the methods of 400 and 500 may be integrated in any useful manner and the steps may be performed in any useful sequence.

The exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid-state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method, the method comprising:
monitoring a number of fixed wireless devices on a frequency band served by a serving access node;
determining that the number of fixed wireless devices on the frequency band served by the serving access node has exceeded a threshold; and
transmitting a notification to one or more neighboring access nodes, the notification including the number of fixed wireless devices served by the serving access node on the frequency band, and the frequency band serving the fixed wireless devices.

2. The method of claim 1, wherein the notification to the one or more neighboring access nodes further includes an indication that the serving access node is not accepting new wireless device handovers for the frequency band serving the fixed wireless devices.

3. The method of claim 1, the method further comprising:
determining that the number of fixed wireless devices on the frequency band served by the serving access node is at or has dropped below the threshold; and
transmitting a notification to the one or more neighboring access nodes, the notification including the number of fixed wireless devices on the frequency band served by the access node, the frequency band serving the fixed wireless devices, and indicating that the serving access node is accepting new wireless device handovers for the frequency band.

4. The method of claim 1, the method further comprising:
monitoring a traffic level in the frequency band serving the fixed wireless devices;
determining that the traffic level in the frequency band serving the fixed wireless devices is below a first traffic threshold; and
responsive to determining that the traffic level in the frequency band is below the first traffic threshold, transmitting the number of fixed wireless devices being served by the serving access node, the frequency band on which the fixed wireless devices are being served, and an indication that the serving access node is accepting new wireless device handovers for the frequency band.

5. The method of claim 1, the method further comprising:
transmitting, on a schedule, the number of fixed wireless devices being served by the serving access node, and the frequency band on which the fixed wireless devices are being served.

6. The method of claim 5, the method further comprising:
determining that the serving access node is no longer serving fixed wireless devices on the frequency band; and
responsive to determining that the serving access node is no longer serving fixed wireless devices on the frequency band, transmitting an indication that the serving access node is accepting wireless device handovers for the frequency band, and stopping the schedule of transmissions.

7. The method of claim 5, the method further comprising:
upon detecting a change in the number of fixed wireless devices on the frequency band served by the serving access node, modifying the schedule for transmitting the number of fixed wireless devices being served by the serving access node, and the frequency band on which the fixed wireless devices are being served, based at least in part on the change in the number of fixed wireless devices on the frequency band served by the serving access node.

8. The method of claim 5, the method further comprising:
upon detecting a change in a traffic level exceeding a change threshold on the frequency band served by the serving access node, modifying the schedule for transmitting the number of fixed wireless devices being served by the serving access node, and the frequency band on which the fixed wireless devices are being served, based at least in part on the change in the traffic level on the frequency band served by the serving access node.

9. A method, the method comprising:
receiving from an access node a count of how many fixed wireless devices the access node is serving within a cell provided by the access node;
determining that a wireless device is subject to a handover procedure;
deprioritizing the cell in a list of target cells for handover of the wireless device responsive to the count being at or above a first threshold; and
completing the handover procedure for the wireless device.

10. The method of claim 9, the method further including:
determining that the count is at or above a second threshold, and
excluding the cell from the list of target cells for handover of the wireless device.

11. The method of claim 9, the method further comprising:
determining that the count is below the first threshold; and
setting the cell to normal priority on the list of target cells for handover of the wireless device.

12. The method of claim 9, the method further comprising:
receiving from the access node, an indication that traffic in the cell serving the one or more fixed wireless devices is below a traffic threshold; and
setting the cell to normal priority on the list of target cells for handover of the wireless device.

13. A system, the system comprising:
an access node including at least one electronic processor configured to perform operations, the operations including:
monitoring a number of fixed wireless devices on a frequency band served by the access node;
determining that the number of fixed wireless devices on the frequency band served by the access node has met or exceeded a threshold; and
transmitting a notification to one or more neighboring access nodes, the notification including the number of fixed wireless devices on the frequency band served by the access node, and the frequency band serving the fixed wireless devices.

14. The system of claim 13, wherein the notification to the one or more neighboring access nodes further includes an indication that the access node is not accepting new wireless device handovers for the frequency band serving the fixed wireless devices.

15. The system of claim 13, the operations further including:
determining that the number of fixed wireless devices on the frequency band served by the access node has dropped below the threshold; and
transmitting a notification to the one or more neighboring access nodes, the notification including the number of fixed wireless devices on the frequency band served by the access node, the frequency band serving the fixed wireless devices, and indicating that the access node is accepting wireless device handovers for the frequency band.

16. The system of claim 13, the operations further including:
monitoring a traffic level in the frequency band serving the fixed wireless devices;
determining that the traffic level in the frequency band serving the fixed wireless devices is below a traffic threshold; and
responsive to determining that the traffic level in the frequency band is at or below the traffic threshold, transmitting the number of fixed wireless devices being served by the access node, the frequency band on which the fixed wireless devices are being served, and an indication that the access node is accepting wireless device handovers for the frequency band.

17. The system of claim 13, the operations further including:
transmitting to the one or more neighboring access nodes, on a schedule, the number of fixed wireless devices being served by the access node and the frequency band on which the fixed wireless devices are being served.

18. The system of claim 17, the operations further including:
determining that the access node is no longer serving fixed wireless devices on the frequency band; and
responsive to determining that the access node is no longer serving fixed wireless devices on the frequency band, transmitting an indication that the access node is accepting wireless device handovers for the frequency band, and stopping the schedule of transmissions.

19. The system of claim 17, the operations further including:
upon detecting a change in the number of fixed wireless devices on the frequency band served by the access node, modifying the schedule for transmitting the number of fixed wireless devices being served by the access node, and the frequency band on which the fixed wireless devices are being served, based at least in part on the change in the number of fixed wireless devices on the frequency band served by the access node.

20. The system of claim 17, the operations further including:
monitoring a traffic level on the frequency band serving the fixed wireless devices; and
upon detecting a change in the traffic level exceeding a change threshold on the frequency band serving the fixed wireless devices, modifying the schedule for transmitting the number of fixed wireless devices being served by the access node, and the frequency band on which the fixed wireless devices are being served, based at least in part on the change in the traffic level on the frequency band serving the fixed wireless devices.
